(19) United States
(12) Patent Application Publication
(10) Pub. No.: US 2001/0050905 A1
(43) Pub. Date: Dec. 13, 2001

(54) Device and method for switching transmission direction

(76) Inventor: Pi-Yuan Shin, Taipei (TW)

Correspondence Address: BROWN PINNISI & MICHAELS, 400 M & T BANK BUILDING, 118 NORTH TIOGA ST, ITHACA, NY, 14850

(21) Appl. No.: 09/865,775

(22) Filed: May 25, 2001

(30) Foreign Application Priority Data
Jun. 13, 2000 (TW) 089111535

(51) Int. Cl. H04L 5/16

(52) U.S. Cl. 370/296; 370/276

(57) ABSTRACT

A transmission direction switching device for a half-duplex communication apparatus includes a data transmission detector connected to a universal asynchronous receiver transmitter (UART) via a sending line and a direction-switching rule executor connected to a half-duplex communication interface driver having a signal subtraction function via a direction control line. The data transmission detector detects any data to be sent and sends the data if such data exists. The direction-switching rule executor receives the data sent by the data transmission detector and sends a direction switching signal via the direction control line to the half-duplex communication interface driver to set a transmission direction of the half-duplex communication interface driver to a sending direction when the data received from the data transmission detector is a signal 0 or a low signal, or sends a direction switching signal via the direction control line to the half-duplex communication interface driver to set a transmission direction of the half-duplex communication interface driver to a receiving direction when the data received from the data transmission detector is a signal 1 or a high signal.

### FIELD OF THE INVENTION

The present invention relates to device and method for switching transmission direction, and more particularly to device and method adapted to switch transmission direction independent of data format and transmission speed.

### BACKGROUND OF THE INVENTION

In recent years, personal computers have been developed at a surprisingly quick speed and become more and more popular among consumers year by year. With the popularity of personal computers, there is also the need of connecting a personal computer to various kinds of electronic apparatus. The electronic apparatus connected to a personal computer might be another personal computer or some other electronic instruments. To successfully connect a personal computer to other electronic apparatus, it is necessary to use a standardized interface, for example, a RS-485 interface.

The use of a standardized interface is also required in the connection of the personal computer to its peripherals, that is, input/output (I/O) apparatus. Peripherals (I/O) are apparatus surrounding a personal computer for inputting data into the computer or receiving data from the computer, such as keyboard, printer, monitor, etc. The peripherals are connected to a computer via cables. Before the peripherals could be connected to the computer, considerations about the compatibility of mechanical structures of the personal computer with the peripherals, as well as the consistence in data transmission parameters between the personal computer and the peripherals must be taken. The data transmission parameters are generally referred to as communication protocols.

A communication protocol includes the transmission speed or baud rate, the number of data bits, the parity, the number of stop bits, the number of data to be transmitted, the transmission manner of half duplex/full duplex, etc. The RS-485 interface known in the art allows only half-duplex transmission. Meanwhile, when there is any change in the transmission speed, it is necessarily to adjust settings for the transmission speed. A description of the technology adopted in the conventional RS-485 will now be made as below. Please refer to FIG. 1 that is a block diagram showing a conventional data transmission direction switching for a conventional half-duplex communication interface, wherein a transmission direction switching device is used to control the transmission direction. A universal asynchronous receiver transmitter (UART) 130, a transmission direction switching device 200, and a decoding circuit are separately coupled to a bus 100, and the UART 130 is further connected to a half-duplex communication interface driver 140.

The transmission direction switching device 200 outputs via a direction control line 210 a control signal to the half-duplex communication interface driver 140, so as to change the data transmission direction thereof. The bus 100 receives in-coming data via a receiving line 170 and sends out-going data via a sending line 190. Generally, a default data transmission direction is the receiving direction. When the bus 100 is to send a data via the sending line 190, the sending direction is reverse to the default receiving direction. In this condition, it is impossible to complete the sending of data. Thus, in order to send out the data, the transmission direction switching device 200 implements the switching of direction by sending a direction control signal via a direction control line 210 to the half-duplex communication interface driver 140 to change the data transmission direction thereof.

Before the bus 100 sends out a data, it must set a transmission rate and a data format for the UART 130 connected thereto. To do this, the bus 100 sends a message concerning format and rate to the UART 130. Meanwhile, the transmission direction switching device 200 detects the format and rate message from the bus 100 and calculates based on such format and rate message a basic transmission time corresponding to the data to be sent. The basic transmission time is also the duration for the switched transmission direction or the time period for sending the data to be sent. When the basic time is reached, the sending of data is completed, too. At this point, the data transmission direction is restored to the receiving direction.

The transmission direction switching device 200 is connected to the sending line 190 for detecting a start bit of the data to be sent. When the start bit is detected, a direction control signal is sent via the direction control line 210 to the half-duplex communication interface driver 140, so that the latter is immediately switched from the data receiving direction to the sending direction. Meanwhile, the basic transmission time starts at this point and the sending of data via the sending line 190 starts. When the basic transmission time is reached, the sending of data is completed, too. At this point, the transmission direction switching device 200 sends a direction control signal via the direction control line 210 to the half-duplex communication interface driver 140 for the same to restore to the default receiving direction.

Please refer to FIG. 2 that is a detailed block diagram of the transmission direction switching device 200. As shown, the transmission direction switching device 200 includes a real-time intercepting means 201 connected to the bus 100 for intercepting messages concerning format and transmission rate of the data to be sent and outputting a basic transmission data. A programmable basic-time generator 202 connected to the real-time intercepting means 201 receives the basic transmission date from the real-time intercepting means 201 and generates a basic transmission time that is sent to an automatic transmission direction controller 204 connected to the basic-time generator 202.

The automatic transmission direction controller 204 is operative to receive the basic transmission time from the programmable basic-time generator 202 and to receive a direction-switching signal from an automatic start-bit detector 203 connected to the sending line 190. When the automatic start-bit detector 203 detects a start bit via the sending line 190, it outputs a direction-switching signal to the automatic transmission direction controller 204, which, on receipt of the direction-switching signal, switches via the direction control line 210 the default receiving direction to the sending direction. Duration of the sending direction is decided depending on the basic transmission time from the programmable basic-time generator 202. When the basic transmission time is reached, the sending of data is completed, too. At this point, the sending direction is restored via the direction control line 210 to the default receiving direction.

From the above description, it can be found that the conventional transmission direction switching device 200 must detect from the bus 100 messages concerning the format and the transmission rate of the data to be sent, as well as detect from the sending line 190 the start bit, in order to control the transmission direction. Moreover, when the transmission speed changes, settings for the transmission speed must be correspondingly adjusted. As a result, the conventional transmission direction switching device 200 has very complicate design. It is therefore desirable to develop simplified device and method to attain the same transmission-direction control function as the prior device does.

### SUMMARY OF THE INVENTION

A primary object of the present invention is to provide a transmission direction switching device that works without the need of retrieving the format of the transmitted data.

Another object of the present invention is to provide a transmission direction switching device that works without the need of retrieving the transmission rate at which the data is transmitted.

A further object of the present invention is to provide a transmission direction switching device that works without the need of setting a transmission speed.

To achieve the above and other objects, the transmission direction switching device of the present invention mainly includes a data transmission detector connected to a universal asynchronous receiver transmitter (UART) via a sending line and a direction-switching rule executor connected at an end to the data transmission detector and at another end to an interface of a half-duplex communication interface driver via a direction control line.

The data transmission detector detects any data to be sent and sends the data to the direction-switching rule executor if such data exists. The direction-switching rule executor receives the data sent by the data transmission detector and implements the switching of transmission direction of the half-duplex communication interface driver based on the following rule: a direction switching signal is sent via the direction control line to set a transmission direction of the half-duplex communication interface driver to a sending direction when the data received from the data transmission detector is a signal 0 or a low signal, or a direction switching signal is sent via the direction control line to set a transmission direction of the half-duplex communication interface driver to a default receiving direction when the data received from the data transmission detector is a signal 1 or a high signal.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram showing the data transmission direction switching for a conventional half-duplex communication interface, wherein a transmission direction switching device is used to control the transmission direction;

FIG. 2 is a detailed block diagram of the transmission direction switching device of FIG. 1;

FIG. 3 is a block diagram showing the data transmission direction switching for a half-duplex communication interface according to the present invention, wherein a transmission direction switching device is used to control the transmission direction;

FIG. 4 is a detailed block diagram of the transmission direction switching device and the half-duplex communication interface driver of FIG. 3; and

FIG. 5 exemplifies the change of a signal from A to D in the transmission direction switching process shown in FIG. 4.

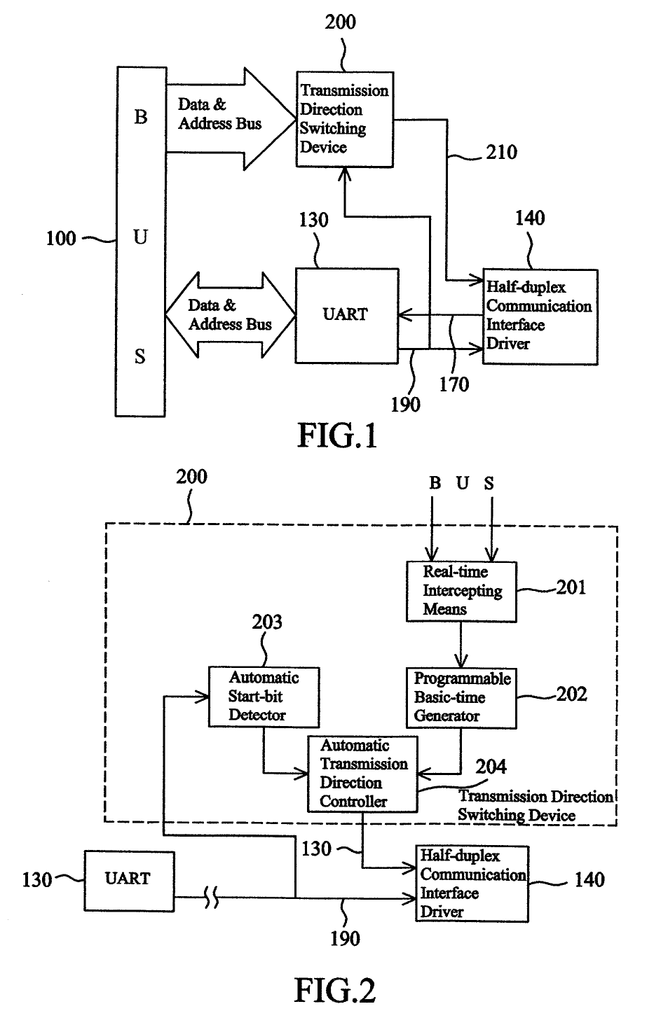

### DETAILED DESCRIPTION OF THE PREFERRED EMBODIMENTS

The present invention relates to a method for switching transmission direction by taking advantage of an existing signal subtraction function of a half-duplex communication interface driver and a transmission direction switching device provided by the present invention. With the method of the present invention, transmission direction may be switched without the need of detecting the transmitted data format and resetting a transmission speed when the same is changed.

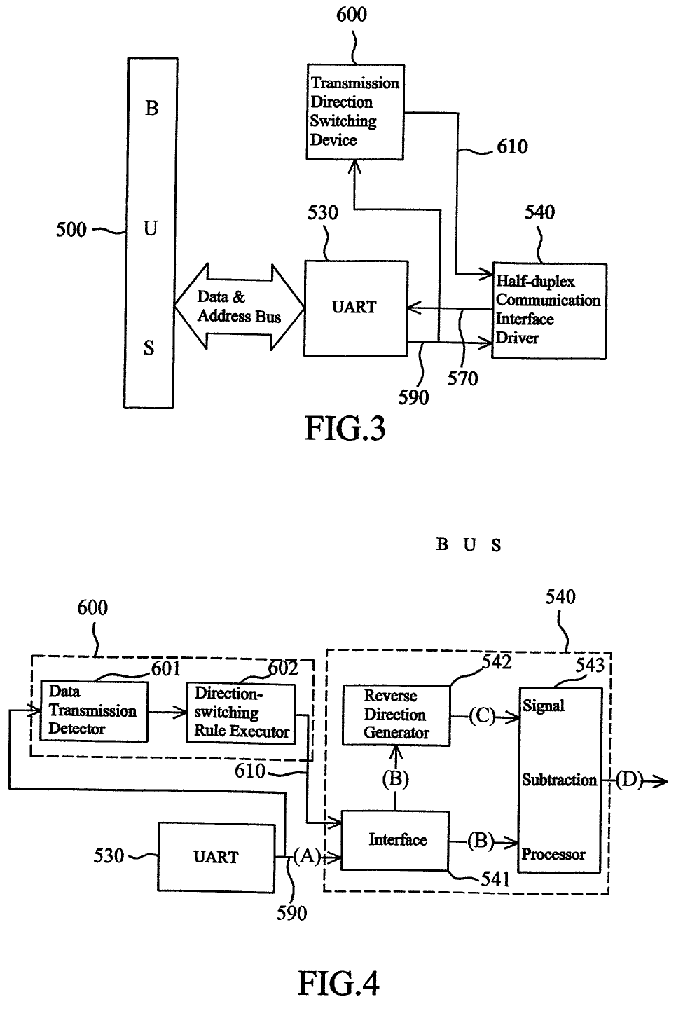

Please refer to FIG. 3 that is a block diagram showing the data transmission direction switching for a half-duplex communication interface according to the present invention, wherein a transmission direction switching device 600 is used to control a transmission direction of a half-duplex communication interface driver 540. The transmission direction switching device 600 and a universal asynchronous receiver transmitter (UART) 530 are separately coupled to a bus 500, while the UART 530 is further connected to the half-duplex communication interface driver 540.

The transmission direction switching device 600 outputs via a direction control line 610 a control signal to the half-duplex communication interface driver 540, so as to change the data transmission direction of the driver 540. The bus 500 receives in-coming data via a receiving line 570 and sends out-going data via a sending line 590. Generally, a default data transmission direction is the receiving direction. When the bus 500 is to send a data via the sending line 590, the sending direction is reverse to the default receiving direction. In this condition, it is impossible to complete the sending of data. Thus, in order to send out the data, the transmission direction switching device 600 implements the switching of transmission direction by sending a direction control signal via the direction control line 610 to the half-duplex communication interface driver 540, so as to change the data transmission direction thereof.

The transmission direction switching device 600 is connected to the sending line 590 for detecting any data to be sent. When there is data to be sent, the transmission direction switching device 600 sends out a direction control signal to the half-duplex communication interface driver 540 via the direction control line 610 in compliance with a specific rule, so as to timely switch the transmission direction of the driver 540. The rule adopted in the present invention for switching transmission direction is to set the transmission direction to a sending direction when the transmitted data is a signal 0 or a low signal; and a receiving direction when the transmitted data is a signal 1 or a high signal. The method for switching the transmission direction according to the present invention will now be described in more details as below.

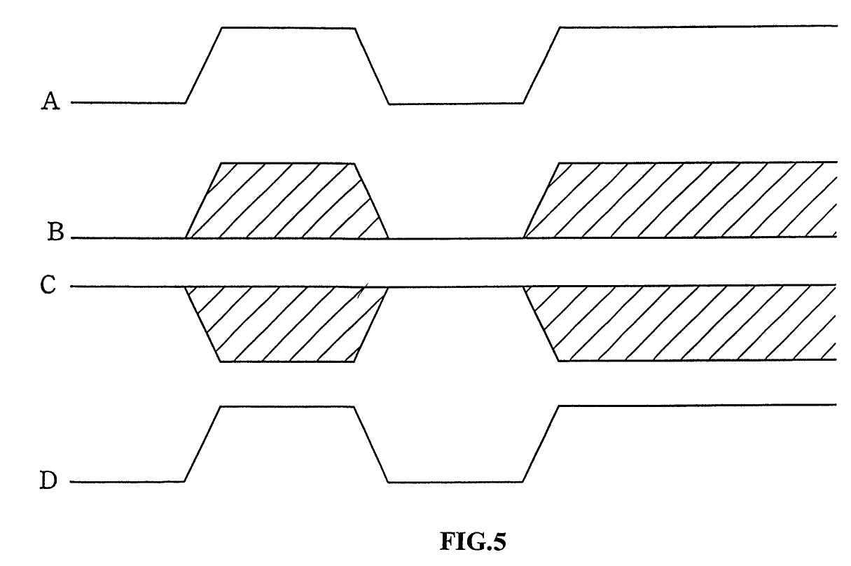

Please refer to FIG. 4 that is a detailed block diagram of the transmission direction switching device 600 and the half-duplex communication interface driver 540. The transmission direction switching device 600 is a programmable logic device including a data transmission detector 601 and a direction-switching rule executor 602. The data transmission detector 601 is connected to the sending line 590, and the direction-switching rule executor 602 is connected at an end to the data transmission detector 601 for receiving a signal from the data transmission detector 601 and at another end via the direction control line 610 to an interface 541 in the half-duplex communication interface driver 540.

The data transmission detector 601 is connected to the sending line 590 for detecting any data to be sent.

When there is data to be sent, the data transmission detector 601 sends out further information about data transmission to the direction-switching rule executor 602 for the same to start switching the transmission direction of the half-duplex communication interface driver 540. The rule adopted by the direction-switching rule executor 602 to switch the transmission direction is to send via the direction line 610 a direction-switching signal to the half-duplex communication interface driver 540 and to change the default receiving direction of the driver 540 to the sending direction when the transmitted data from the data transmission detector 601 is a signal 0 or a low signal; and to send via the direction line 610 a direction-switching signal to the half-duplex communication interface driver 540 and to restore the sending direction to the default receiving direction of the driver 540 when the transmitted data from the data transmission detector 601 is a signal 1 or a high signal.

The half-duplex communication interface driver 540 includes, in addition to the interface 541, a reverse-direction generator 542 and a signal subtraction processor 543. The interface 541 receives a transmission data via the sending line 590 and a direction-switching signal via the direction control line 610. When the transmission data from the sending line 590 is a signal 0 or a low signal, the direction-switching signal from the direction control line 610 switches the transmission direction of the interface 541 to a sending direction, so that the signal 0 or low signal is sent via the interface 541 to both the signal subtraction processor 543 and the reverse-direction generator 542.

When the transmission data from the sending line 590 is a signal 1 or a high signal, the direction-switching signal from the direction control line 610 switches the transmission direction of the interface 541 to a receiving direction. At this point, the signal over the sending line 590 is in the state of high impedance and is sent to the signal subtraction processor 543 and the reverse-direction generator 542 via the interface 541. Please refer to FIG. 5. When the data over the sending line 590 is A, a signal sent out from the interface 541 is B.

Now, please refer back to FIG. 4. The reverse-direction generator 542 is connected to the interface 541 for receiving messages from the interface 541. The reverse-direction generator 542 reverses the input data so that a signal output therefrom is a reverse of the input signal. As shown in FIG. 5, message B is reversed by the reverse-direction generator 542 to message C.

Turn back to FIG. 4 again. The signal subtraction processor 543 is connected to the interface 541 and to the reverse-direction generator 542 and functions to subtract the signal output by the reverse-direction generator 542 from the signal output by the interface 541, so that a signal identical to that previously over the sending line 590 is obtained and output. Go to FIG. 5, the signal subtraction processor 543 subtracts signal C from signal B and outputs a signal D, which is identical to the previous signal over the sending line 590.

The present invention has been described with a preferred embodiment thereof and it is understood that many changes and modifications in the described embodiment can be carried out without departing from the scope and the spirit of the invention. For example, the direction-switching rule executor 602 may, based on a signal A output by the data transmission detector 601, generate a signal-A that is a reverse of the signal A, and then executes subsequent steps based on the rule of setting the transmission direction to the receiving direction when the signal−A is zero or low, and setting the transmission direction to the sending direction when the signal−A is 1 or high.

In brief, the transmission direction switching device 600 of the present invention works without the need of detecting from the bus 500 messages concerning the format and the transmission speed or detecting a start bit from the sending line 590 in controlling the transmission direction. In addition, with the transmission direction switching device 600, it is no need to adjust settings for transmission speed when the transmission speed changes. Thus, the design of the transmission direction switching device 600 is largely simplified as compared with a conventional transmission direction switching device 200. The signal subtraction operation is implemented through the existing function of a half-duplex communication interface driver known in the art and does not involve in too much complicate design. Therefore, in implementing transmission direction switching with the present invention, (1) considerations about data format and data transmission rate may be ignored; and (2) adjusting of transmission speed for the entire system from time to time could be saved.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A transmission direction switching device for a half-duplex communication apparatus, said half-duplex communication apparatus including a universal asynchronous receiver transmitter (UART) and a half-duplex communication interface driver having a signal subtraction function and connected to said UART via a sending line and to said transmission direction switching device via a direction control line; said transmission direction switching device comprising:
a data transmission detector coupled to said sending line for detecting any data to be sent and sending said data if such data exists; and
a direction-switching rule executor for receiving said data sent out by said data transmission detector, and sending a direction switching signal via said direction control line to said half-duplex communication interface driver to set a transmission direction of said half-duplex communication interface driver to a sending direction when said data received from said data transmission detector is a signal 0 or a low signal, or sending a direction switching signal via said direction control line to said half-duplex communication interface driver to set a transmission direction of said half-duplex communication interface driver to a receiving direction when said data received from said data transmission detector is a signal 1 or a high signal.

2. The transmission direction switching device as claimed in claim 1, wherein said half-duplex communication interface driver comprises a driver in compliance with RS485 standard.

3. The transmission direction switching device as claimed in claim 1, wherein said transmission direction switching device is a programmable logic device.

4. A transmission direction switching device for a half-duplex communication apparatus, said half-duplex communication apparatus including a universal asynchronous receiver transmitter (UART) and a half-duplex communication interface driver having a signal subtraction function and connected to said UART via a sending line and to said transmission direction switching device via a direction control line; said transmission direction switching device comprising:
a data transmission detector coupled to said sending line for detecting any data to be sent and sending said data if such data exists; and
a direction-switching rule executor for receiving said data sent out by said data transmission detector and generating a negative data in reverse to said data received from said data transmission detector; and said direction-switching rule executor sending a direction switching signal via said direction control line to said half-duplex communication interface driver to set a transmission direction of said half-duplex communication interface driver to a sending direction when said negative data is a signal 0 or a low signal, or sending a direction switching signal via said direction control line to said half-duplex communication interface driver to set a transmission direction of said half-duplex communication interface driver to a receiving direction when said negative data is a signal 1 or a high signal.

5. The transmission direction switching device as claimed in claim 4, wherein said half-duplex communication interface driver comprises a driver in compliance with RS485 standard.

6. The transmission direction switching device as claimed in claim 4, wherein said transmission direction switching device is a programmable logic device.

7. A method for switching transmission direction of a half-duplex communication apparatus, said half-duplex communication apparatus including a universal asynchronous receiver transmitter (UART) a half-duplex communication interface driver having a signal subtraction function, and a transmission direction switching device; said half-duplex communication interface driver being connected to said UART via a sending line and to said transmission direction switching device via a direction control line; and said transmission direction switching device including a data transmission detector and a direction-switching rule executor; said method comprising the steps of:
detecting any data transmission by using said data transmission detector coupled to said sending line to detect any data to be sent and sending said data if such data exists; and
implementing transmission direction switching by using said direction-switching rule executor to receive said data sent by said data transmission detector, such that said direction-switching rule executor sends a direction switching signal via said direction control line to said half-duplex communication interface driver to set a transmission direction of said half-duplex communication interface driver to a sending direction when said data received from said data transmission detector is a signal 0 or a low signal, or sends a direction switching signal via said direction control line to said half-duplex communication interface driver to set a transmission direction of said half-duplex communication interface driver to a receiving direction when said data received from said data transmission detector is a signal 1 or a high signal.

8. The method for switching transmission direction as claimed in claim 7, wherein said half-duplex communication interface driver comprises a driver in compliance with RS485 standard.

9. The method for switching transmission direction as claimed in claim 7, wherein said transmission direction switching device is a programmable logic device.

10. A method for switching transmission direction of a half-duplex communication apparatus, said half-duplex communication apparatus including a universal asynchronous receiver transmitter (UART) a half-duplex communication interface driver having a signal subtraction function, and a transmission direction switching device; said half-duplex communication interface driver being connected to said UART via a sending line and to said transmission direction switching device via a direction control line; and said transmission direction switching device including a data transmission detector and a direction-switching rule executor; said method comprising the steps of:
detecting any data transmission by using said data transmission detector coupled to said sending line to detect any data to be sent and sending said data if such data exists; and
implementing transmission direction switching by using said direction-switching rule executor to receive said data sent by said data transmission detector and generate a negative data in reverse to said data received from said data transmission detector, such that said direction-switching rule executor sends a direction switching signal via said direction control line to said half-duplex communication interface driver to set a transmission direction of said half-duplex communication interface driver to a sending direction when said negative data is a signal 0 or a low signal, or sends a direction switching signal via said direction control line to said half-duplex communication interface driver to set a transmission direction of said half-duplex communication interface driver to a receiving direction when said negative data is a signal 1 or a high signal.

11. The method for switching transmission direction as claimed in claim 10, wherein said half-duplex communication interface driver comprises a driver in compliance with RS485 standard.

12. The method for switching transmission direction as claimed in claim 10, wherein said transmission direction switching device is a programmable logic device.
